(19) United States
(12) Patent Application Publication
(10) Pub. No.: US 2025/0236087 A1
(43) Pub. Date: Jul. 24, 2025

(54) SPLICING UNIT FOR DUNNAGE CONVERSION MACHINE

(71) Applicant: Pregis LLC, Chicago, IL (US)

(72) Inventor: Andrew Grundy, Saint Albans (GB)

(21) Appl. No.: 19/035,676

(22) Filed: Jan. 23, 2025

Related U.S. Application Data
(60) Provisional application No. 63/624,631, filed on Jan. 24, 2024.

(51) Int. Cl. B31D 5/00; B65H 37/04; B65H 43/00

(52) U.S. Cl. CPC B31D 5/0052; B65H 37/04; B65H 43/00; B31D 2205/0035; B31D 2205/0088; B65H 2801/63

(57) ABSTRACT

A splicing unit is included with a dunnage conversion machine that converts a supply of stock material into a dunnage product, where the splicing unit includes: a support surface configured to provide backing for a first strip of stock material, and a sensor operatively connected to the dunnage conversion machine, the sensor being associated with the support surface for detecting a presence of the first strip of sheet material and upon determining that the first strip of stock material has passed the sensor, stopping operation of the dunnage conversion machine. A brake may be arranged adjacent to the support surface in order to contact the first strip of stock material arranged on the support surface upon stopping operation of the dunnage conversion machine.

### CROSS-REFERENCE TO RELATED APPLICATION

The present application claims under 35 U.S.C. § 119(e) the benefit of U.S. Provisional Application Ser. No. 63/624,631 filed on Jan. 24, 2024, the entire contents of which are incorporated by reference herein.

### BACKGROUND

### Technical Field

The present disclosure is directed to a splicing unit for a dunnage conversion machine, more particularly, to the splicing unit including at least a support surface and a sensor for sensing runout of a supply of fan-fold paper.

### Description of the Related Art

It is known to operate a dunnage conversion machine using a supply of fan-fold paper, or by pulling a web of material from a roll. Typically, when using the supply of fan-fold paper or the web of material on the roll, an operator must manually stop operation of the dunnage conversion machine, and splice a trailing end of a last sheet of an existing supply of fan-fold paper or web to a leading end of a first sheet of a new supply of fan-fold paper (or a beginning of a new roll). However, this process is inefficient, and may require the operator to awkwardly bend down to locate the last sheet and then re-feed the supply of fan-fold paper or web into the dunnage conversion machine once splicing has been completed. Additionally, the last several pieces of dunnage can be of lower quality than the preceding pieces.

### SUMMARY

According to the present disclosure, a splicing unit for a dunnage conversion machine that converts a supply of stock material into a dunnage product may include: a support surface configured to provide backing for a first strip of stock material; and a sensor operatively connected to the dunnage conversion machine, the sensor being associated with the support surface and configured to detect a presence of the first strip of sheet material and upon determining that the first strip of stock material has passed the sensor, stopping operation of the dunnage conversion machine.

The splicing unit may further include a brake arranged adjacent to the support surface, the brake configured to contact the first strip of stock material arranged on the support surface upon stopping operation of the dunnage conversion machine.

The brake may include a brush including a plurality of bristles configured to contact the stock material.

The brake may include a surface that is configured to grip the stock material without tearing the stock material.

The support surface may be configured to receive a second strip of sheet material to splice to the first strip of sheet material. The second strip of sheet material may be received through a series of splicing rollers. The splicing rollers may be positioned upstream of the support surface and a series of dunnage rollers are positioned downstream of the support surface.

The support surface may be positioned at a height which is located above the first strip of stock material.

The support surface may be positioned at a height adjacent to a work surface that receives dunnage from the dunnage conversion machine.

The stock material may be fan-folded. The stock material may include a plurality of stacks of fan-folded stock material spliced in series.

According to the present disclosure, a system for converting dunnage from stock material into a dunnage product may include a dunnage conversion machine configured to convert a sheet of the stock material into the dunnage product, and a splicing unit positioned upstream of the dunnage conversion machine. The splicing unit may include a support surface configured to provide backing for a first strip of stock material; and a sensor operatively connected to the dunnage conversion machine, the sensor being associated with the support surface and configured to detect a presence of the first strip of sheet material and upon determining that the first strip of stock material has passed the sensor, stopping operation of the dunnage conversion machine.

The sheet of stock material may be routed through a series of dunnage rollers that direct the stock material into the dunnage conversion machine.

A brake may be arranged adjacent to the support surface, where the brake holds the first strip of stock material at a location upstream of the dunnage rollers and the first strip of stock material remains routed through the dunnage rollers.

The splicing unit may include a series of splicing rollers for routing a second strip of stock material and onto the support surface for splicing to the first strip of stock material when the first strip of stock material is positioned at the stop.

According to the present disclosure, a method of supplying stock material into a dunnage conversion machine configured to convert the stock material into a dunnage product may include: receiving a strip of stock material on a support surface of a splicing unit, the splicing unit located upstream of the dunnage conversion machine; detecting, by a sensor at the splicing unit, that a supply of stock material is depleted; and upon detecting that the supply of stock material is depleted, stopping the dunnage conversion machine from converting the stock material, and holding a trailing end of the strip of stock material on the support surface.

According to the method, the trailing end of the strip of stock material may be held at the support surface by a brake. The brake may be a brush configured to stop the stock material without tearing the stock material.

The method may further include a step of splicing a leading end of a new sheet of stock material to the trailing end of the strip of stock material at the support surface.

According to the method, the supply of stock material may remain routed through dunnage rollers when the trailing end of the supply of stock material is held at the support surface.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic view of a system for converting dunnage including a conversion machine and a splicing unit operably connected to the conversion machine;

FIG. 2 is an enlarged view of the splicing unit of FIG. 1;

FIG. 3 is a side view of the system of FIG. 1 in which a supply of stock material is pulled over the splicing unit and fed through the conversion machine during operation of the conversion machine;

FIG. 4 is an isolated view of a fan-fold supply of stock material for use in the system of FIG. 1;

FIG. 5 is a schematic view of the splicing unit of FIG. 1 in which a supply of stock material is stopped at the splicing unit; and

FIG. 6 is a schematic view of the splicing unit of FIG. 1 in which a new supply of stock material is spliced to an existing supply of stock material, after the supply of stock material is stopped.

### DETAILED DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant disclosure, in combination with routine experiments, to achieve other outcomes not specifically disclosed in the examples or the embodiments.

Protective packaging articles are configured for placement within a packaging container or between items being shipped or stored, to protect the items, fill void space within the packaging container, and/or to prevent or inhibit the items from moving around within the container. The protective packaging articles include protective-fill articles that are typically provided individually or as a plurality of units that are configured to be placed into the void space to provide a desired level of packaging. Such units typically are of a predetermined size or can have predetermined dimensions and/or be selectively configurable in another dimension, such as length. In some examples, the size of the protective-fill articles can be configurable in a plurality or all of their dimensions. Protective-fill articles are typically resiliently compressible around corners, edges, and/or sides of a packaged item to fill the void space around the item, instead of assuming a solid shape that corresponds to the void space around the item. Protective-fill articles include, for example, void-fill articles and cushioning articles. Examples of cushioning materials include inflatable air pillows and cushions, bubble wrap, paper dunnage with a loft structure capable of withstanding moderate shocks and impact, foam sheets, and packing peanuts.

Paper-based protective packaging, or dunnage, is produced by crumpling or otherwise deforming paper stock. More specifically, paper dunnage is produced by running a generally continuous strip of paper through a dunnage conversion machine. The continuous strip of paper can be provided from, for example, a roll of paper or a fan-fold stack of paper. The dunnage conversion machine converts the paper stock material into a lower density paper dunnage material using, for example, opposing rollers between which the paper stock material is passed. The rollers grip and pull the paper stock material from the roll or stack, and deform the paper stock material as the material passes between the rollers. The resulting paper dunnage can be cut into desired lengths to form individual pieces (or paper cushions or pillows) that can be provided to effectively fill a void space within a container holding a product.

The supply units of stock material may have fan-fold configurations. For example, a foldable material, such as paper, may be folded repeatedly to form a stack or a three-dimensional body. The term “three-dimensional body,” in contrast to the “two-dimensional” material, has three dimensions all of which are non-negligible. A continuous sheet, e.g., a sheet of paper, plastic, or foil, can be folded at multiple fold lines that extend transversely to a longitudinal direction of the continuous sheet, or transversely to the feed direction of the sheet. For example, folding a continuous sheet that has a substantially uniform width along transverse fold lines can form or define sheet sections that have approximately the same width. The continuous sheet can be folded sequentially, in opposite or alternating directions, to produce an accordion-shaped continuous sheet. For example, the folds may form or define sections along the continuous sheet, and the sections may be substantially rectangular.

For example, sequentially folding the continuous sheet may produce an accordion-shaped continuous sheet with sheet sections that have approximately the same size and/or shape as one another. Multiple adjacent sections that are defined by the fold lines can be generally rectangular, and can have the same first dimension, e.g., a dimension corresponding to the width of the continuous sheet, and the same second dimension that is generally along longitudinal direction of the continuous sheet. For example, when the adjacent sections are contacting one another, the continuous sheet may be configured as a three-dimensional body or a stack, in an accordion shape that is formed by the folds and be compressed, so that the continuous sheet forms a three-dimensional body or stack.

The fold lines of the stock material can have any suitable orientation relative to one another, as well as relative to the longitudinal and transverse directions of the continuous sheet. Also, the stock material unit can have transverse folds that are parallel one to another. For example, the sections that are formed by the fold lines can be compressed to form a three-dimensional body that is a rectangular prismoid. Also, the stock material can have one or more folds that are non-parallel relative to the transverse folds.

The stock material can be provided as any suitable number of discrete stock material units. For example, two or more stock material units can be connected together to provide a continuous feed of material into the dunnage conversion machine. The material can be fed from the connected stock material units sequentially or concurrently, i.e., in series or in parallel. The stock material units can have various suitable sizes and configurations, and may include one or more stacks or rolls of suitable sheet materials. The term “sheet material” refers to a material that is generally sheet-like and two-dimensional, i.e., two dimensions of the material are substantially greater than the third dimension so that the third dimension is negligible or de minimus in comparison to the other two dimensions. Also, the sheet material can be generally flexible and foldable, such as the illustrative materials described herein.

The stock material units can include an attachment mechanism that connects multiple units of stock material, for example, to produce a continuous material feed from multiple discrete stock material units. The respective end and beginning of consecutive rolls can be joined by adhesive or other suitable means, to facilitate daisy-chaining the rolls together to form a continuous stream of sheet material that can be fed into the protective packaging machine, e.g., a dunnage conversion machine. The mechanisms used for splicing or connecting multiple units of stock material with one another are commonly referred to as splicing members. Splicing members can include a substrate layer and an adhesive layer, alternatively splicing members include cohesives, i.e., a material that strongly bonds with a corresponding cohesive material and weakly bonds with other materials. Examples of suitable dunnage conversion machines include those disclosed in U.S. Patent Application Publication No. US 2019/0193364 published on Jun. 27, 2019; U.S. Pat. No. 11,235,548 issued Feb. 1, 2022; and U.S. Ser. No. 18/340,805 filed on Jun. 23, 2023. Additional examples of splicing members are disclosed in U.S. Pat. No. 11,305,506 and U.S. Pat. No. 11,020,930. In some cases, when the stock material units include two-ply stock material, the stock material may be spliced through various sandwiching configurations. For example, adhesive can extend along the interior or exterior ends of sheet material and the plies of sheet material that is being spliced may sandwich the exterior or be inserted between the two plies depending on the desired configuration.

The adhesive used in the splicing members may include any suitable adhesive (e.g., pressure sensitive adhesive). Pressure sensitive adhesives may be selected that bond non-adhesive members together after applying a slight, initial, external pressure to create the bond. Examples of these include water-based, acrylic, pressure sensitive adhesives, similar to what is applied to packaging tape in that the material holds two surfaces together solely by surface contact, often upon a slight initial external pressure. Pressure sensitive adhesives can be selected that are aggressive and permanently tacky at room temperature. Examples of water based, acrylic, pressure sensitive adhesives include those known as RHOPLEX N-1031 Emulsion, RHOPLEX N-580 Emulsion, and RHOPLEX N-619 Emulsion.

In some embodiments, dry adhesives may also be used, as they may typically not require activation with water, solvent or heat, and firmly adhere to many dissimilar surfaces. Other emulsion polymers or acrylic polymer blend adhesives are also contemplated and other suitable types of adhesives and of contact adhesives can be used.

In some examples, the adhesive layer is pressure sensitive such that the adhesive layer forms an adhesive bond with a non-adhesive member when pressure is applied to the adhesive layer and the non-adhesive member. In some examples, the adhesive layer is not pressure sensitive such that the adhesive layer forms an adhesive bond with a non-adhesive member when little to no pressure is applied to the adhesive layer and the non-adhesive member, and instead, the adhesive layer contacts the non-adhesive member and a bond is formed. In an example, the adhesive layer may be in the form of a double sided tape that may be used to secure the first non-adhesive member to the second non-adhesive member.

In some embodiments, the adhesive layer includes an adhesive layer capable or configured to hold or couple two non-adhesive members together by surface attachment or interlocking action. In some examples, the adhesive layer includes a substrate with a layer of adhesive applied or bonded to at least one surface. In some examples, the adhesive layer includes a substrate with a layer of adhesive on a first surface and a layer of adhesive on a second surface, where the second surface is opposite the first surface.

In use, in an example, the adhesive layer may be secured to a first non-adhesive member through a surface attraction or interfacial force. In some examples, the first non-adhesive member may be coupled with, attached to, or form part of a stack retainer or a strip of sheet material. The adhesive layer secured to the first non-adhesive member may then be secured to a second non-adhesive member, thereby securing together the first non-adhesive member and the second non-adhesive member. In some examples, the second non-adhesive member may be an alternate or second strip of sheet material.

In some embodiments, the securement or adhesion of the first non-adhesive member and the second non-adhesive member is generally permanent, such that the first non-adhesive member and the second non-adhesive member may not be easily separated. In some embodiments, the securement or adhesion of the first non-adhesive member and the second non-adhesive member may be non-permanent, such that the first non-adhesive member and the second non-adhesive member may be easily separated.

In some examples, a connector may include an adhesive layer and a release layer. In some examples, the connector can include an adhesive layer and a substrate with a release property such that the adhesive layer may be releasably stuck to the substrate. The adhesive layer may be initially positioned adjacent the release layer to allow for the easy separation of the adhesive layer with respect to the release layer. In some examples, a connector having an adhesive layer may be positioned in a first position adjacent a release layer. In some examples, the first position may include a shipping and handling position, which is remote from the position used for splicing the sequential strips of supply material. In such examples, a user repositions the connector to a second position so that the connector may be used to splice or connect the components of two stock material units together.

Folding a continuous sheet along the transverse fold lines can form or define generally rectangular sheet sections. The rectangular sheet sections can stack together by, for example, folding the continuous sheet in alternating directions, to form the three-dimensional body that has longitudinal, transverse, and vertical dimensions. In some applications, the transverse direction of the continuous sheet of stock material can be greater than one or more dimensions of the intake. For example, the transverse dimension of the continuous sheet can be greater than the diameter of a generally round intake. Reducing the width of the continuous sheet in this manner at the start of the conversion process can facilitate passage thereof into the intake. The decreased width of the leading portion of the continuous sheet may facilitate smoother entry and/or transition of a daisy-chained continuous sheet and/or may reduce or eliminate catching or tearing of the continuous sheet. Moreover, reducing the width of the continuous sheet at the start thereof can facilitate connecting together or daisy-chaining two or more stock material units. For example, connecting or daisy-chaining material with a tapered section may be accomplished using smaller connectors or splice elements than would be required otherwise. Also, tapered sections may be easier to manually align and/or connect together in comparison to full-width sheet sections.

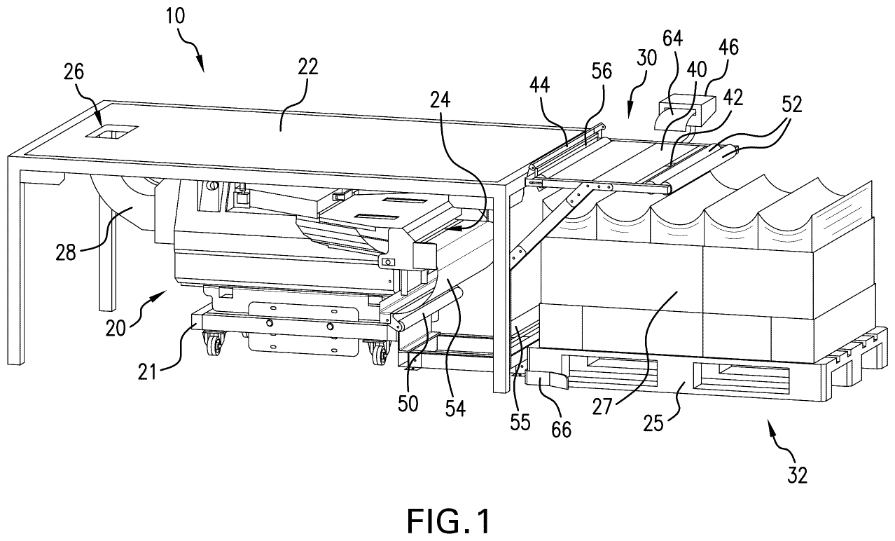

FIGS. 1 through 6 depict a system 10 for converting stock material to dunnage that includes a protective packaging machine 20, a work surface 22, and a splicing unit 30. The above components of the system 10 may be arranged at a workstation of an operator who operates the protective packaging machine 20, commonly referred to as a conversion machine (or dunnage conversion machine), so as to dispense protective packaging material. The protective packaging machine 20 includes an inlet 24 and an outlet 26, and is configured to convert dunnage from a supply of stock material 32 (i.e., existing supply of stock material) that is fed into the protective packaging machine 20 via the inlet 24. As shown in FIG. 1, the protective packaging machine 20 may be arranged underneath a table, and optionally may be supported by a platform 21. As provided herein, the platform 21 may be arranged on wheels for conveniently moving the protective packaging machine 20 relative to the workstation or between workstations.

In the system 10 depicted in FIG. 1, the horizontal surface of the table is defined by the work surface 22, and the work surface 22 may be used by an operator to receive finished paper products (e.g., pads) that are propelled from the protective packaging machine 20 via a chute 28 to the outlet 24 of the protective packaging machine 20 for use as packaging materials, for example, for loading by the operator situated at the workstation. In particular, the operator may load finished pads into a separate container such as a cardboard box for cushioning one or more items contained in the cardboard box. As provided herein, the work surface 22 of the table includes an opening for receiving pads that exit the protective packaging machine 20 via the outlet 26.

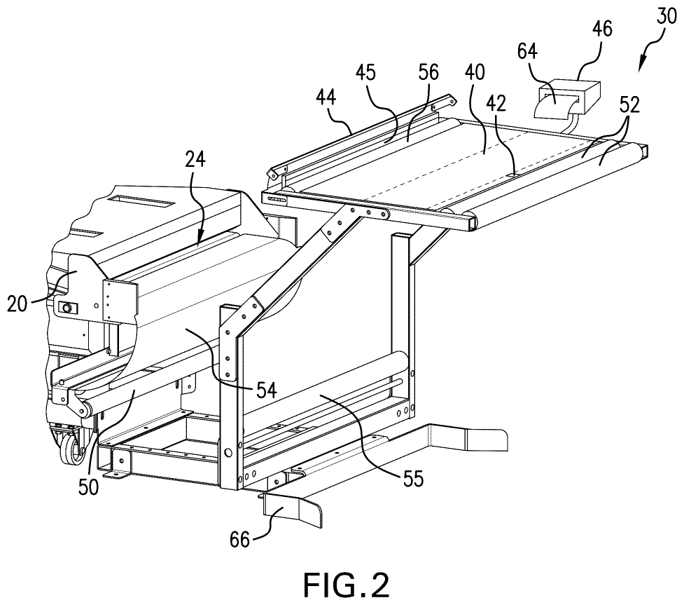

The splicing unit 30 is defined by a splicing support surface 40, e.g., a horizontal support surface arranged on the splicing unit 30. At a minimum, the splicing support surface 40 serves as a backing surface that may contact the supply of stock material 20 during operation of the protective packaging machine 20, and is configured to provide a backing for allowing the operator to carry out a splicing operation once the protective packaging machine 20 is slowed or stopped. Alternatively, instead of a horizontal surface, the splicing support surface 40 may be a vertical surface, a diagonal surface, or another orientation. In addition, the splicing support surface 40 may be flat or curved, straight or tapered, planar or non-planar, or any other arrangement. The splicing unit 30 having the splicing support surface 40 is configured to allow for splicing a new supply of stock material with the existing supply of stock material 32 when the existing supply of stock material 32 is depleted or nearly depleted. Referring to FIG. 2, e.g., the splicing support surface 40 preferably has a width that is greater than or equal to a width of the supply of stock material that passes through splicing rollers 52 at a first end (i.e., a proximal end or upstream end) of the splicing unit 30. The splicing unit 30 preferably includes one or more splicing rollers 56 at a second end (i.e., a distal end or downstream end) of the splicing unit 30. In the example depicted in FIGS. 1-3, the splicing roller 56 may be a single roller configured to receive the stock material 32 between a brake 44 and the splicing roller 56, as described herein. Alternatively, it is possible for the splicing support surface 40 to have a width that is smaller than a width of stock material received at the splicing unit 30, depending on the arrangement of the splicing rollers 52 and/or 56.

As shown in FIGS. 1 and 2, a dispenser 46 or supply of splicing element(s) or member(s) 64 (also referred to as splices) may be arranged adjacent to the splicing support surface 40. For example, the dispenser 46 may be arranged on a platform that is connected to the table and/or the splicing unit 30, or may be a stand-alone device preferably positioned near or adjacent to the splicing unit 30. The splicing members 64 dispensed by the dispenser 46 may include adhesive-or cohesive-based elements, and may be a single-sided tape, double-sided tape (e.g., 3M X-series general purpose double coated tape), a cohesive, an element with a release layer, a sticker, or any other suitable splicing mechanism. The splicing members include discrete, pre-cut elements, and/or a roll of tape of indeterminate length for allowing the operator to form a splice of a desired length. The splicing members 64 may be dispensed manually from the dispenser 46, or automatically upon actuation of a sensor 42 arranged on the splicing unit 30, where operation of the sensor 42 is described later. Alternatively, the web of paper itself (e.g., the stock material 32 defined by the roll or fan-folded sheets) may include a release layer that can be peeled off to expose an adhesive or cohesive, which may be used to facilitate splicing to another web of paper.

The splicing unit 30 is operably connected to the protective packaging machine 20. The splicing unit 30 includes the splicing support surface 40, the sensor 42, and the brake 44. The splicing support surface 40 is configured to receive stock material from the supply of stock material 32 prior to the supply of stock material 32 being routed to the protective packaging machine 20. The supply of stock material 32 may include one or more stacks of fan-folded sheets, or alternatively, may be a roll of sheet material. In particular, a leading end of the stock material 32 may be threaded through the splicing rollers 52 and 56, thus passing over the splicing support surface 40, and thereafter be nipped by a set of rollers 55 arranged between the splicing unit 30 and the protective packaging machine 20. The protective packaging machine 20 is arranged downstream of the splicing unit 30, and includes rollers 50 and a guide 54, as described herein, for feeding the stock material 32 into the protective packaging machine 20. Details of the splicing unit 30 will now be described.

The sensor 42 is preferably associated with the splicing unit 30, and for example, may be fixed to the splicing unit 30 are provided adjacent thereto. The sensor 42 is configured to detect when the supply of stock material 32 is depleted. The sensor 42 may be configured to detect when a trailing end of a sheet of stock material passes over the splicing unit 30. The sensor 42 may be located on the splicing support surface 40 such that the supply of stock material 32 is routed over the sensor 42. In particular, when a trailing end of the supply of stock material 32 passes over the sensor 42, the sensor 42 is able to determine that the supply of stock material 32 has run out. Alternatively, the sensor 42 may be configured to sense a mark on the sheet of stock material, and thereby determine when the stock material 32 from the fan-folded sheets or the web of material from a roll has run out. The sensor 42 may be a photo-electric sensor, a proximity sensor, an ultra-sonic sensor, an infrared sensor or any other suitable sensor. For example, the sensor 42 may be a presence detector or a binary sensor that detects when stock material is present or absent. Alternatively, instead of a single sensor 42, multiple sensors may be provided. For example, the multiple sensors can be arranged at one or more locations on the splicing support surface 40 so as to detect one or more sections of a trailing sheet of stock material.

Once the sensor 42 detects that the supply of stock material 32 has been depleted, or the sensor 42 detects that there is an absence of a sheet of stock material, the sensor 42 may cause the protective packaging machine 20 to shift into stand-by mode or otherwise stop, e.g., by actuating a shutdown switch, thus suspending conversion of the stock material 32. In some embodiments, the sensor 42 is connected to a controller (not shown) that is operably connected to the protective packaging machine 20 and stops the protective packaging machine 20 from operating. Alternatively, the sensor 42 may trigger a gradual shutdown of the protective packaging machine 20, e.g., after a delay of about 1 to 3 seconds. As a further alternative, the sensor 42 may simply slow down operation of the protective packaging machine 20, in order to provide the operator with sufficient time to perform a splicing operation on the splicing support surface 40.

The sensor 42 may be operable to cause the supply of stock material 32 to stop or slow down at the splicing unit 30, typically on the splicing support surface 40. The stock material 32 can be slowed, stopped, and/or held by the brake 44, which is a mechanical element configured to engage the supply of stock material 32 that moves over the splicing support surface 40.

Referring to FIG. 2, the brake 44 may be in the form of a brush including a series of bristles 45 that are fixed to a metal support (e.g., made of aluminum), where the bristles 45 preferably are arranged transversely along the brake 44 in order to gently engage with the supply of stock material 32 (e.g., a sheet/strip/web of stock material) while allowing the supply of stock material 32 to pass through the splicing unit 30. As provided herein, the brake 44 is either stationary or may be spring-loaded to passively allow the sheet of stock material to pass over the bristles 45 of the brake 44. The brake 44 optionally may apply a frictional force to the stock material 32 which stops the supply of stock material 32. In particular, the brake 44 may be configured to stop the supply of stock material 32 such that the trailing end 25 of the stock material is positioned at the splicing support surface 40 thereby allowing the trailing end 25 of the stock material 32 to be spliced easily to a leading end of a new supply of stock material 32. The bristles 45 of the brake 44 may be formed from any natural substance or a polymer such as nylon or polypropylene.

The brake 44 may be configured to stop the stock material 32 (e.g., paper) from moving without damaging the stock material 32 by applying pressure via the bristles 45 of the brake 44, for example. The bristles 45 are configured to deflect and gently apply pressure, thereby holding the stock material 32 in place. For example, the bristles 45 may be formed of a stiff material that resiliently retains them in a straight position. In this way, when the bristles 45 are pushed into the trailing end of the paper, they deflect with enough force to hold the paper in place. Alternatively, additional pressure can be applied via a spring or other device. Instead of a brush with bristles, the brake 44 may be any other device or structure capable of stopping movement of the stock material 32 at the splicing unit 30. For example, the brake 44 may be a frictional member, a high-friction rubber, an electro-mechanical brake, one or more fingers, two or more pinch rollers, a soft blade, or any other suitable device capable of stopping the supply of stock material 32.

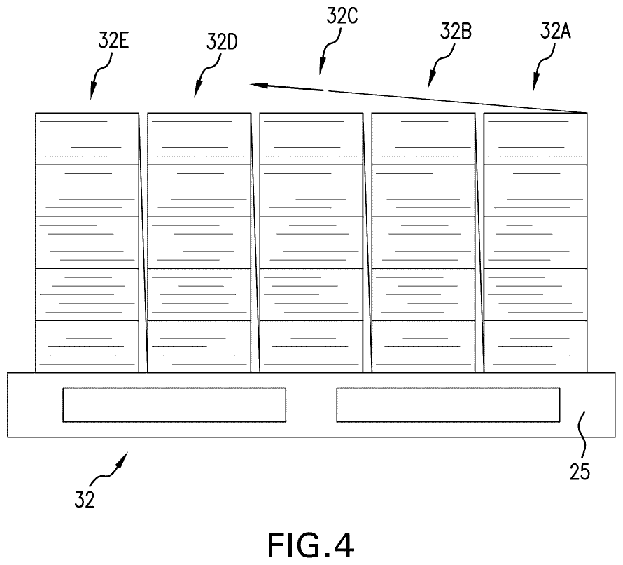

As shown in FIGS. 1, 3, 4, and 6, the supply of stock material 32 may be positioned on a pallet 25 which when depleted can be replaced by a new pallet of stock material. The stock material 32 preferably is arranged in a fan-folded sheet configuration on the pallet 25. The stock material 32 includes stacks 32A-32E (see FIG. 4). The stacks 32A-32E are pre-spliced together, for example, using any of the methods disclosed herein. As shown in FIG. 4, the pre-spliced stacks 32A-32E may be arranged on the pallet 25, where the stacks 32A-32E may be consecutively used until each stack 32A-32E is depleted. Once depleted, a new supply of stock material 32 may be spliced to the depleted supply in any manner discussed herein at the splicing unit 30. Optionally, the stacks 32A-32E may be subdivided into a plurality of blocks and combined (e.g., spliced together), as shown in FIG. 4. Alternatively, the supply of stock material 32 can be a roll, stacks, or any other suitable supply of stock material.

As provided herein, the stock material 32 may be arranged on the pallet 25 and surrounded by a skirt 27, e.g., a cardboard skirt that surrounds the stacks 32A-32E to maintain the stacks 32A-32E in position on the pallet 25. The pallet 25 may be held in place relative to the splicing unit 30 by a fork 66, which serves as a guide to receive the pallet 25. In the present embodiment, the fork 66 holds the pallet 25 in place. The pallet 25 may then easily be moved away from the system 10 once depleted and a new pallet with new stacks of stock material can then be moved into place relative to the splicing unit 30. Instead of the fork 66, any other suitable mechanism may be used to hold the pallet 25 in place as the stock material 32 is converted. For example, one or more of the following alternatives may be provided: a frictional pad, a clamping mechanism, a mechanism that is inserted into the pallet 25, a fitting that the pallet 25 is placed into or any other suitable mechanism.

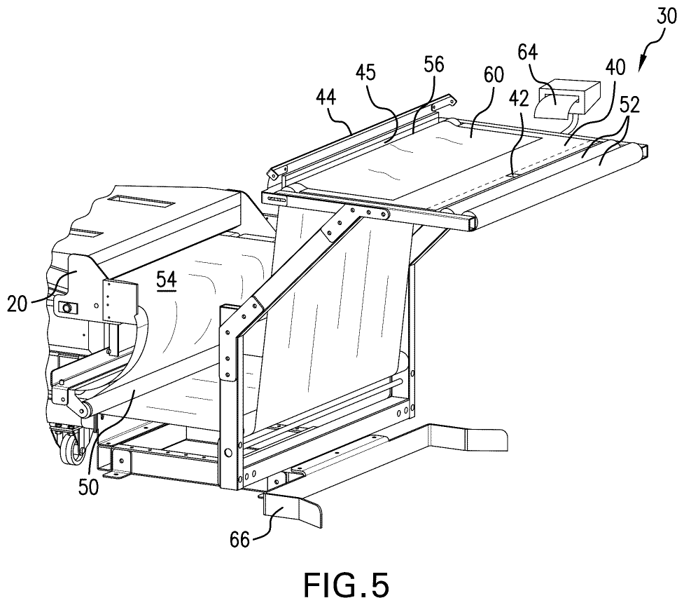

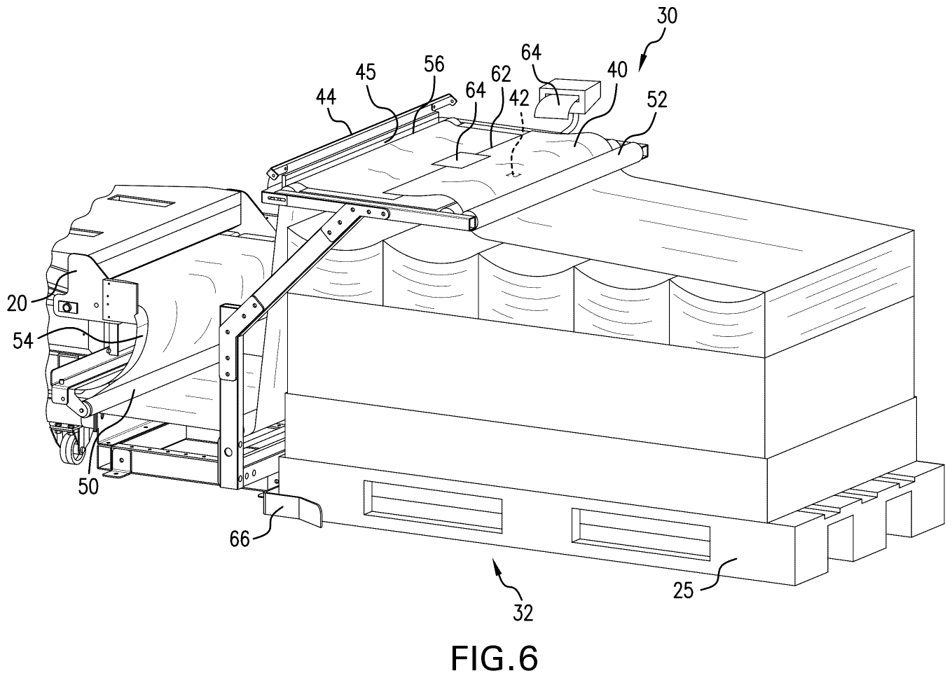

As discussed above, the supply of stock material 32 can be stopped at the splicing support surface 40. The splicing support surface 40 is configured to provide a suitable surface to splice, daisy-chain, connect, etc. a new supply of stock material to the stock material that has been depleted as detected by the sensor. Referring to FIG. 5, the brake 44 is depicted as holding a sheet of the stock material 32 relative to the splicing support surface 40 after a trailing end 60 has passed the sensor 42. Referring to FIG. 6, the leading end 62 of a new supply of stock material 32 is schematically shown being spliced via the splicing member 64 to the trailing end 60 of the supply of stock material 32 such that a continuous supply of stock material 32 is routed to the protective packaging machine 20 when a new supply of stock material 32 is being loaded or used without the need for routing the new supply of stock material into the protective packaging machine 20. Optionally, an additional brake (similar to the brake 44) may be provided at the first end (upstream end, proximal end) of the splicing support surface 40 in order to hold the new sheet of paper that is being spliced in place so that it does not slip during a splicing operation. The splicing member 64 optionally may be dispensed by the dispenser 46 arranged at or near the splicing support surface 40 so as to be easily accessible by an operator who is undertaking the splicing operation on the splicing support surface 40.

The splicing support surface 40 is depicted as being located above the supply of stock material 32 which allows for the supply of stock material to easily be routed into the splicing unit 30 for splicing as discussed above. In other examples, the splicing support surface 40 can be positioned at any other location. The splicing support surface 40 is configured to allow for ergonomic and convenient splicing of a depleted supply to a new supply of stock material 32. As shown in FIGS. 1-6, the splicing support surface 40 is configured as a horizontal surface. The splicing support surface 40 may be configured as being oriented in any other suitable orientation, for example, at any suitable angle that allows for ergonomic splicing of supplies of sheet material to one another. As discussed above, the supplies of sheet material can be spliced using any suitable method such as those provided by the references discussed above, e.g., adhesive, cohesive, or any other suitable splicing mechanism.

As depicted in FIG. 6, the trailing end 60 of the supply of stock material 32 is configured to be spliced to the leading end 62 of a new sheet of stock material. The trailing end 60 and leading end 62 are held together by the splicing member 64. The splicing member 64 is depicted as being positioned at a central location transversely to connect the leading end 62 and the trailing end 60, but can be positioned anywhere along transverse edges of the trailing and leading ends 60, 62, and optionally may be positioned in plural locations. In some examples where the supply of stock material 32 includes multiple plies, a splicing member may be configured to extend from edge to edge on the leading or trailing end on the interior or exterior of the plies of the leading or trailing end depending on the desired configuration. The plies may then sandwich the splicing members on the exterior or interior depending on where the splicing member is positioned. It will be appreciated that the sheet material may be spliced in any known configuration including, without limitation, a configuration with the splicing member only on the center of the leading or trailing end of the stock material, or with a splicing member only on the edges of the leading or trailing end of the stock material.

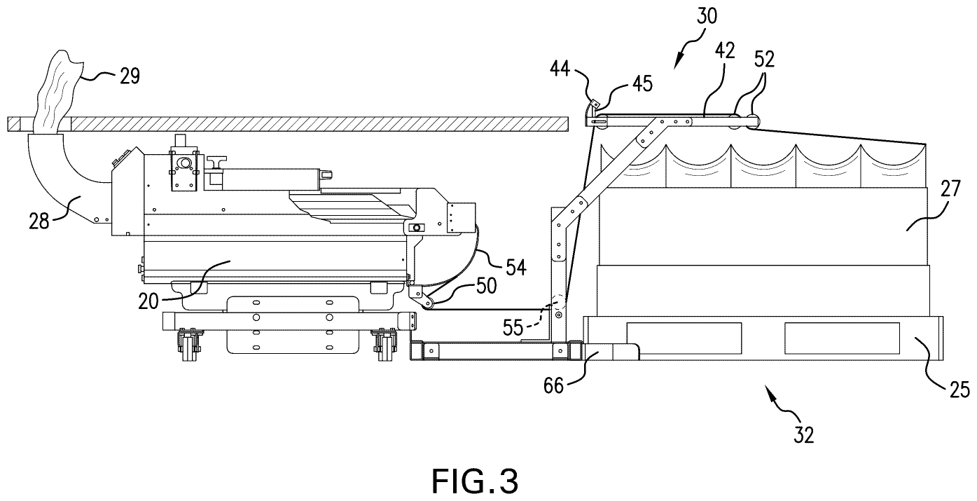

Referring to FIGS. 1 through 4, the protective packaging machine 20 preferably converts one or multiple plies of paper-based stock material (i.e., high-density paper) into a lower-density pad. For example, the multiple plies may be held together by a zipper formed by the protective packaging machine 20. The protective packaging machine 20 may include a separating/cutting device having a blade, and may be configured to separate or cut the packaging articles prior to the packaging articles entering the work surface 22. The work surface 22 preferably is arranged at the outlet 26 of the protective packaging machine 20 downstream of the blade of the separating/cutting device. An operator may receive the separated or cut packaging articles (e.g., pads) at the work surface 22, and arrange one or more pads for packaging purposes. Referring to FIG. 3, a pad 29 may exit the chute 28 after being cut by the cutting device that is part of the protective packaging machine 20, and preferably the pad is a predetermined length and thickness. For example, the pad may have a minimum height of about 2 cm or 4 cm and a maximum height of about 6 cm or 8 cm. The pad may have a minimum length of about 1 cm or 3 cm and a maximum length of about 80 cm or 100 cm. The height and length of the pad may be set in advance, or during operation of the protective packaging machine 20 to any range within the above minimums and maximums. The work surface 22 is depicted as configured as a table positioned over the protective packaging machine 20. Preferably the support surface 40 is positioned at approximately the same height as the work surface 22 for convenience of the operator, but optionally may be positioned above or below the work surface 22.

As discussed above, after being routed through the splicing unit 30, the supply of stock material 32 is routed to the protective packaging machine 20. The splicing unit 30 is preferably located upstream of the protective packaging machine 20. The splicing unit 30 additionally is depicted as including the splicing rollers 52 and 56 arranged at opposite ends of the splicing support surface 40. The splicing rollers 52 route the supply of stock material 32 through the splicing unit 30 and to the protective packaging machine 20. The system 10 optionally includes a set of rollers 55 arranged between the splicing unit 30 and the protective packaging machine 20. The protective packaging machine 20 includes packaging unit rollers 50 that route the supply of stock material 32 from the splicing unit 30 and/or the rollers 55 into the protective packaging machine 20. The protective packaging machine 20 additionally may include a guide 54 that is configured to gently guide the supply of stock material 32 into the protective packaging machine 20. Typically, when a new supply of stock material 32 is loaded into the protective packaging machine 20, the user will be required to route the supply of stock material 32 through the series of supply rollers which can be complex and require the user to awkwardly bend over. However, this is circumvented by splicing the depleted stock material at the splicing support surface 40.

FIGS. 5 and 6 depict operation of the splicing unit 30. FIG. 5 depicts the trailing end 60 of the existing sheet traveling over the splicing support surface 40. FIG. 6 depicts the leading end 62 of the supply of stock material that may be spliced to the trailing end 60 of the existing sheet via the splicing member 64. After the trailing end 60 of the stock material 32 has passed over the sensor 42, the protective packaging machine 20 may be operated so as to stop or slow production of dunnage material, and the brake 44 is configured to gently hold the stock material 32 so as to prevent the supply of stock material 32 from traveling over the splicing support surface 40. This allows for the trailing end 60 to be spliced via the splicing member 64 to the leading end 62 of a new sheet of stock material 32 as depicted in FIG. 7. This allows for a continuous flow of stock material through the dunnage conversion machine 20 and for ergonomic splicing of the stock material. As discussed above, optionally, a different brake may be configured to hold the leading end 62 in place.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A splicing unit for a dunnage conversion machine configured to convert a supply of stock material into a dunnage product, the splicing unit comprising:
a support surface configured to provide backing for a first strip of stock material; and
a sensor operatively connected to the dunnage conversion machine, the sensor being associated with the support surface and configured to detect a presence of the first strip of sheet material and upon determining that the first strip of stock material has passed the sensor, stopping operation of the dunnage conversion machine.

2. The splicing unit of claim 1, further comprising a brake arranged adjacent to the support surface, the brake configured to contact the first strip of stock material arranged on the support surface upon stopping operation of the dunnage conversion machine.

3. The splicing unit of claim 2, wherein the brake comprises a brush including a plurality of bristles configured to contact the stock material.

4. The splicing unit of claim 2, wherein the brake includes a surface that is configured to grip the stock material without tearing the stock material.

5. The splicing unit of claim 1, wherein the support surface is configured to receive a second strip of sheet material to splice to the first strip of sheet material.

6. The splicing unit of claim 5, wherein the second strip of sheet material is received through a series of splicing rollers.

7. The splicing unit of claim 6, wherein the splicing rollers are positioned upstream of the support surface and a series of dunnage rollers are positioned downstream of the support surface.

8. The splicing unit of claim 1, wherein the support surface is positioned at a height which is located above the first strip of stock material.

9. The splicing unit of claim 1, wherein the support surface is positioned at a height adjacent to a work surface that receives dunnage from the dunnage conversion machine.

10. The splicing unit of claim 1, wherein the stock material is fan-folded.

11. The splicing unit of claim 10, wherein the stock material comprises a plurality of stacks of fan-folded stock material spliced in series.

12. A system for converting dunnage from stock material into a dunnage product, the system comprising:
a dunnage conversion machine configured to convert a sheet of the stock material into the dunnage product, and
the splicing unit of claim 1 positioned upstream of the dunnage conversion machine.

13. The system of claim 12, wherein the sheet of stock material is routed through a series of dunnage rollers that direct the stock material into the dunnage conversion machine.

14. The system of claim 13, further comprising a brake arranged adjacent to the support surface, wherein the brake holds the first strip of stock material at a location upstream of the dunnage rollers and the first strip of stock material remains routed through the dunnage rollers.

15. The system of claim 12, wherein the splicing unit includes a series of splicing rollers for routing a second strip of stock material and onto the support surface for splicing to the first strip of stock material when the first strip of stock material is positioned at the stop.

16. A method of supplying stock material into a dunnage conversion machine configured to convert the stock material into a dunnage product, the method comprising:
receiving a strip of stock material on a support surface of a splicing unit, the splicing unit located upstream of the dunnage conversion machine;
detecting, by a sensor at the splicing unit, that a supply of stock material is depleted; and
upon detecting that the supply of stock material is depleted, stopping the dunnage conversion machine from converting the stock material, and holding a trailing end of the strip of stock material on the support surface.

17. The method of claim 16, wherein the trailing end of the strip of stock material is held at the support surface by a brake.

18. The method of claim 17, wherein the brake is a brush configured to stop the stock material without tearing the stock material.

19. The method of claim 16, further comprising a step of splicing a leading end of a new sheet of stock material to the trailing end of the strip of stock material at the support surface.

20. The method of claim 16, wherein the supply of stock material remains routed through dunnage rollers when the trailing end of the supply of stock material is held at the support surface.
